(19) United States
(12) Patent Application Publication
(10) Pub. No.: US 2014/0322963 A1
(43) Pub. Date: Oct. 30, 2014

(54) ELECTRICAL CONNECTOR AND METHOD OF ASSEMBLY THEREOF

(71) Applicant: Yasa Motors Limited, Oxfordshire (GB)

(72) Inventors: Jon Barker, Oxfordshire (GB); Mark East, Berkshire (GB)

(73) Assignee: Yasa Motors Limited, Oxfordshire (GB)

(21) Appl. No.: 14/363,519

(22) PCT Filed: Dec. 5, 2012
(86) PCT No.: PCT/GB2012/053017

§ 371 Date: Jun. 6, 2014

(30) Foreign Application Priority Data
Dec. 7, 2011 (GB) 1121047.3

(51) Int. Cl. H01R 13/52; H01R 13/516; H01R 43/20

(52) U.S. Cl. CPC H01R 13/52; H01R 43/20; H01R 13/516
USPC 439/519; 29/428; 439/626

(57) ABSTRACT

The present application includes an electrical connector with an electrically conductive body portion, having a first end for receiving an electrical input and a second end for connection to a further electrical connection, wherein the connector further comprises an outer insulating jacket around an outer diameter of the body portion for insertion into a recess in an outer surface of a casing through which it is desired to pass the electrical connection and wherein the jacket includes a first axial location member at a first end for engagement with a location member in the recess for prevention of movement in a first inward direction and a second axial location member at a second end of the jacket for engagement with a second axial location member provided on a cover securable to an outer surface of the casing for preventing axial movement of the jacket in a second outward direction.

The present invention relates to an electrical connector and method of assembly thereof and relates particularly but not exclusively to such an arrangement when used in a electric motors and generators of the kind generally known as yokeless and segmented armature motors or generators in which a stator is provided with electro-magnetic coils and the rotor is provided with permanent magnets to cooperate with the coils across an air gap between the rotor and stator.

GB 2468019 to Oxford YASA Motors discloses a machine comprising a rotor having permanent magnets and a stator having coils wound on stator bars for interaction with the magnets across an air gap defined between them. The rotor has two stages arranged one at either end of the bars. The bars have a shoe at each end of each bar that links magnetic flux through the bars with said magnets on each stage. Adjacent shoes facing the same stage of the rotor have a high-reluctance shoe gap between them; adjacent magnets on each stage of the rotor have a high-reluctance magnet gap between them; and the shoe and magnet gaps are angled with respect to each other such that they engage progressively as the rotor rotates. Alternatively, the shoes facing each stage are in a ring of connected shoes such that the magnets experience a continuous reluctance that is at least 90% constant as a function of rotor position. The bars and shoes are formed separately from one another and at least a part of each is formed by moulding soft-iron particles so that the particles have a short dimension that is arranged transverse a reluctance-plane. The bars and shoes are assembled so that the reluctance-plane of the bar is parallel a longitudinal axis of the bar and said reluctance—plane of the shoe is transverse said longitudinal axis. Each end of each stator bar is provided with a shoe which serves a physical purpose of confining a coil stack. The coils are mounted within a casing or housing and connected to an external electrical circuit (not shown) that (in the case of a motor) energizes the coils so that the poles of the resultant magnetic fields generated by the current flowing in the coils is opposite in adjacent stator coils. The two rotors carry permanent magnets that face one another with the stator coil between. Indeed, in the axial flux machine, the rotors and their magnets are radially disposed, but when the stator bars are inclined, then they are likewise and have two air gaps disposed between respective shoe and magnet pairs. Preferably, there are a different number of coils and magnets so that each coil does not come into registration with a corresponding magnet pair all at the same time and at the same rotational position of the rotor with respect to the stator.

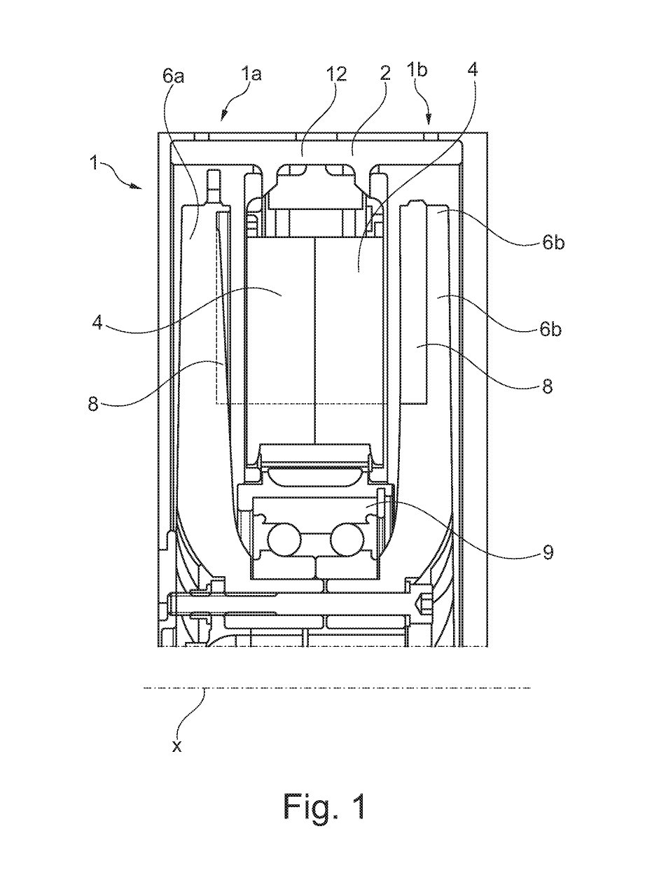

In a motor arrangement the above- mentioned electric circuit is arranged to energize the coils so that their polarity alternates serving to cause coils at different times to align with different magnet pairs, resulting in torque being applied between the rotor and the stator. The rotors are generally connected together (for example by a shaft, not shown) and rotate together about the axis X relative to the stator which is generally fixed (for example in a housing, not shown). The arrangement is illustrated in FIG. 1 which shows that the magnetic circuit is provided by two adjacent stator bars and two magnet pairs whilst the rotor is used for linking the flux between the back of each magnet facing away from the respective coils. Thus, in the case of a motor, by appropriate energization of the coils the rotor is urged to rotate about the axis X. Of course, in the situation of a generator, rotation of the rotor induces currents in the stator coils according to the changing magnetic flux induced in the stator bars as the rotors rotate.

In the above-mentioned arrangement, the electrical leads must be taken through an aperture in the casing and whilst this is relatively easy to do when first assembling the motor or connector it does rely on easy access to the interior of the casing. Such access cannot be achieved once the motor or connector has been assembled. In addition, a cooling fluid is often used to cool the coils and, consequently, the electrical connection between the coils within the casing and the electrical circuit outside of the casing must be such as to prevent any leakage of cooling fluid whilst also ensuring the electrical integrity of the circuit itself.

Presently, it is known to provide the coils with long supply and return leads which are passed through a sealable opening in the casing before being electrically coupled to the supply of electricity on the outside of the casing. The sealable opening relies on the use of a sealing compound applied around the leads which is both difficult to apply and time-consuming. In addition, sealing of multiple leads can be difficult to achieve and any defects are difficult to correct without complete destruction of the seal and re-sealing. Still further, repair of any one electrical connection requires the destruction of the entire seal and re-sealing after the repair has taken place.

Whilst the above-mentioned arrangement provides a perfectly acceptable seal and electrical connection, it has been found that further improvement is possible such as to allow for electrical connections to be assembled and maintained with little if any access to the interior of the casing itself. In addition, the present invention aims to allow the leads to be sealed and connected individually whilst also allowing for the possible removal of the seal and the easy re-creation thereof in the event that repair or maintenance is required. In addition, the leads from the coils may be terminated within the casing itself which aids assembly.

Accordingly, the present invention provides an electrical connector comprising an electrically conductive body portion having a first end for receiving an electrical input and a second end for connection to a further electrical connection, wherein said connector further comprises an outer insulating jacket around an outer diameter of said body portion for insertion into a recess in an outer surface of a casing through which it is desired to pass the electrical connection and wherein said jacket includes a first axial location member at a first end for engagement with a location member in said recess for prevention of movement in a first inward direction and a second axial location member at a second end of said jacket for engagement with a second axial location member (provided on a cover securable to an outer surface said casing for preventing axial movement of said jacket in a second outward direction.

Preferably, the connector includes a first anti-rotation member for preventing rotation of said body within said jacket.

Conveniently, said first anti-rotation member includes a flat portion provided on the body and a corresponding flat portion on the jacket.

Preferably, the connector includes a second anti-rotation member for preventing rotation of said jacket within said cover.

Conveniently, said second anti-rotation member comprises a flat portion on said jacket and a flat portion on said cover.

Preferably, said first, inner, seal comprises a compression seal. In a particular arrangement said inner seal comprises one or more deformable seal or seals having a width W and said body portion includes one or more circumferentially extending recesses for receiving said one or more seals and having a depth D less than the width W, and wherein said jacket includes an inner diameter greater than an outer diameter of said body portion such as to cause said seals to be compressed upon insertion of the body portion into the jacket. Conveniently, said second, outer, seal may also comprise a compression seal. In a particular arrangement said second outer seal comprises one or more deformable seal or seals having a width W2 and said jacket includes one or more circumferentially extending recesses for receiving said one or more seals and having a depth D2 less than the width W2, for sealing against a casing. Advantageously, the casing has an aperture through which said connector passes and including an inner surface against which said outer seal may engage for sealing.

Preferably, said jacket includes an axial location member for engagement with a corresponding engagement member on a casing through which it is to pass such as to prevent axial displacement in a first direction FD through said casing. Said axial location member may comprise a circumferentially extending lip extending around an outer diameter of said insulating jacket for engagement with a corresponding circumferentially extending lip on a casing.

Advantageously, the arrangement includes a second axial location member for preventing axial movement of said jacket in a second direction opposite to said first direction. In a preferred arrangement said second axial location member comprises a circumferentially extending lip extending around an outer diameter of said insulation jacket for engagement with a corresponding circumferentially extending lip on a cover to said casing.

Preferably, the arrangement includes a cover for fitment over said jacket and including a circumferentially extending lip for engagement with a corresponding circumferentially extending lip on said jacket.

Conveniently, the arrangement includes a casing for receiving said jacket. Advantageously, said casing includes a circumferentially extending lip for engagement with a corresponding circumferentially extending lip on said jacket.

Advantageously, the arrangement includes a securing member for securing said body portion within said jacket when inserted therein and for preventing axial movement thereof.

Preferably, said body portion extends beyond an end of said jacket and said body portion and including a securing member for securing the body portion within the jacket.

Advantageously, said securing means comprises a circumferentially extending recess on said body portion for receiving a circlip for engagement with both of said body portion and said jacket to restrict axial movement of said body portion relative to said jacket (26).

Conveniently, the arrangement includes a connector securing member for securing an electrical connection to said body portion. In one arrangement said body portion includes a threaded portion and the securing member comprises a bolt for engagement in said threaded portion.

The present invention also provides a method of assembling an electrical assembly as claimed in any one of claims 1 to 18 comprising the steps:
a) inserting said body portion through an aperture in a casing from an inner side thereof;
b) inserting said jacket over said body portion from an outer side thereof;
c) securing said body portion within said jacket; and
d) securing said jacket within said casing.

The present invention will now be more particularly described by way of example only with reference to the accompanying drawings, in which:

FIG. 1 is a cross-sectional view of a motor/generator incorporating an electrical connector according to the present invention;

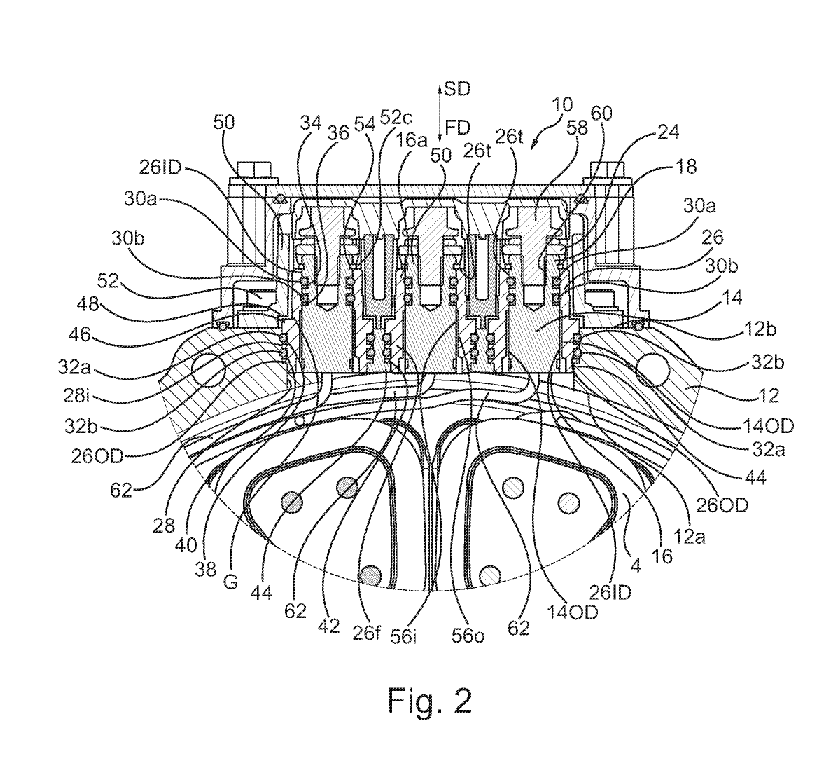

FIG. 2 is a cross-sectional view of the electrical connector according to the present invention;

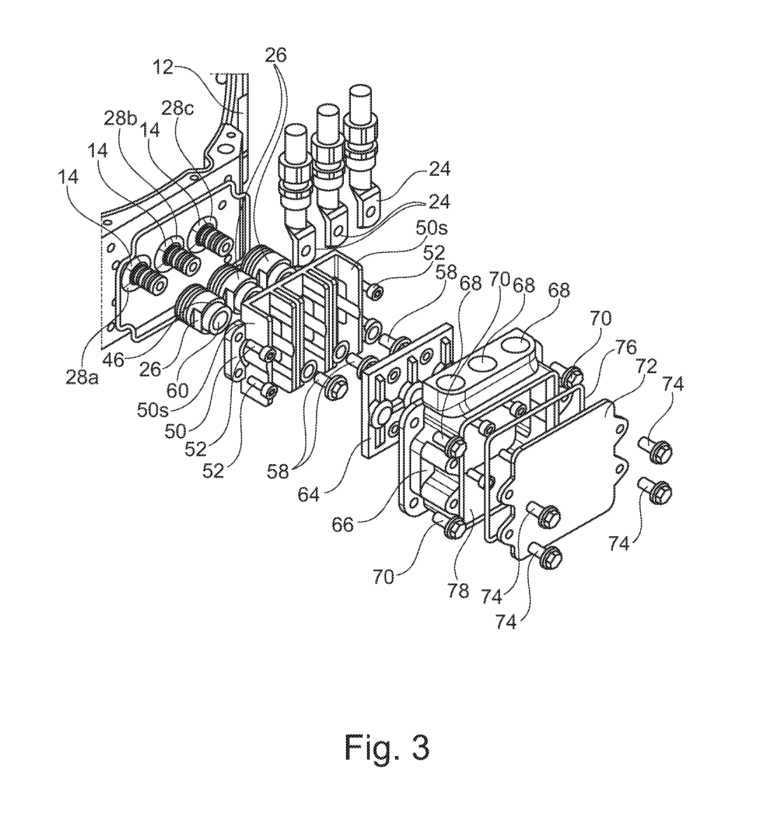

FIG. 3 is an exploded assembly view of the electrical connector shown in FIG. 2; and

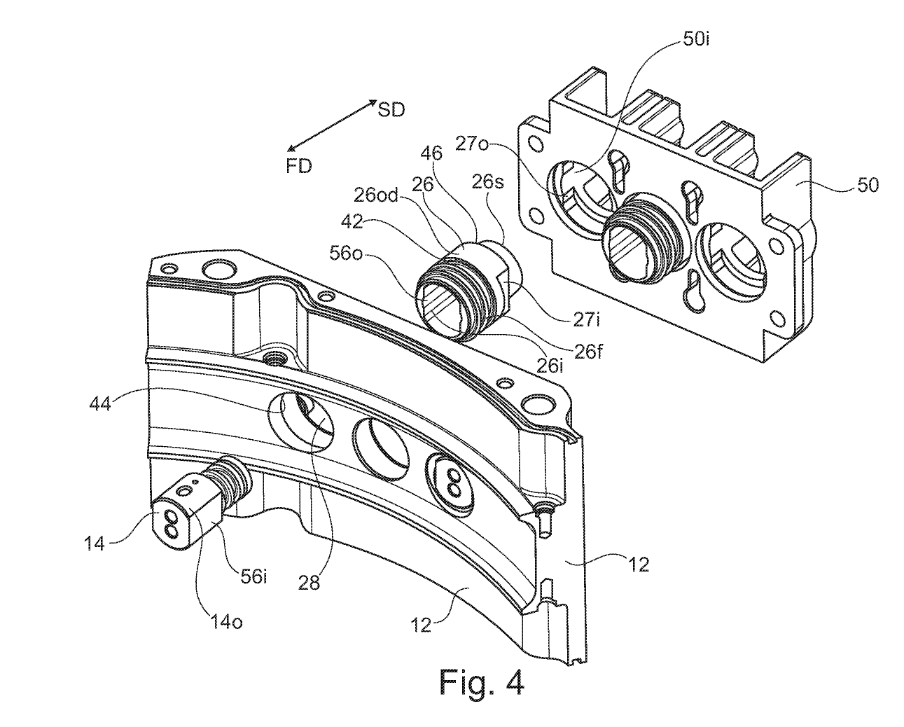

FIG. 4 illustrates an anti-rotation feature of the present invention in more detail than is seen in FIG. 2.

Referring briefly to FIG. 1, an electric motor 1 comprises a stator portion 2 having a plurality of electrical coils 4 circumferentially spaced therearound and around a longitudinal rotation axis X and one or more rotors 6a, 6b includes a plurality of permanent magnets 8 circumferentially spaced therearound and positioned opposite said stator 2 and coils 4. The magnets 8 are spaced from the coils 4 by an air gap G such as to allow rotation of the rotor 6 relative to the stator 2. The magnets 8 are each attached to the rotor 6 which, generally, comprises a magnetic material. The rotor 6 provides a flux path and facilitates the passage of electrical flux between the magnets 8. The rotor 6 is mounted for rotation in a bearing 9 which is itself housed within the stator portion 2 which also forms a casing 12. When the arrangement comprises two or more rotors 6a, 6b are coupled together to move as one and may simply be bolted together by bolts. As shown, the motor 1 is, in fact, two motor slices 1a, 1b bolted together and each motor slice 1a, 1b could be connected to a single output drive, thereby doubling the output torque available. Indeed, there is no limit to the number of motor slices that can be stacked together. The stator portion 2 forms a casing 12 which contains both the coils 4 and the rotors 6 and an electrical connection is provided through the casing, as detailed below.

Referring now to FIGS. 2 and 3, the casing 12 is provided with an electrical connector arrangement shown generally at 10 and including an electrically conductive body portion 14 having a first end 16 for receiving an electrical input and a second end 18 for connection to a further electrical connector 24 provided external to said casing 12. The connector 10 includes an outer insulating jacket 26 around an outer diameter 26OD of the body portion 14 which, in operation, is inserted into an aperture 28 within the casing 12 through which it is desired to pass an electrical connection. The body portion 14 includes a first inner fluid seal 30 between it and the insulating jacket 26 whilst the insulating jacked 26 includes a second outer fluid seal 32 on an outer diameter thereof 26OD for sealing between it and the housing aperture 28. Each of these seals 30, 32 may comprise single or double seals and each may comprise deformable elastomeric materials. Suitable materials include rubber or silicon rubber “O” rings as these may be slid around the members in question. Such seals are compression seals. In more detail, the inner fluid seal 30 comprises one or more deformable seals 30a, 30b having a width W and said body portion 14 includes one or more circumferentially extending recesses 34, 36 for receiving said one or more seals 30, 32 and having a depth D less than the width W, and wherein said jacket 26 includes an inner diameter 26ID only slightly greater than an outer diameter 14OD of said body portion 14 such as to cause said seals 30, 32 to be compressed upon insertion of the body portion 14 into the jacket 26. The dimensioning of such seals and components to effect a suitable seal is well known in the art and not, therefore, described in detail herein. The second outer seal 32 comprises one or more deformable seal or seals 32a, 32b having a width W2 and said jacket 26 includes one or more circumferentially extending recesses 38, 40 for receiving said one or more seals 32a, 32b and having a depth D2 less than the width W2. These seals are sized and positioned relative to the recesses 38, 40 and the aperture 28 in the casing 12 through which said connector 10 passes and an inner surface 28i of said aperture 28 against which said outer seal(s) 32a, 32b may engage such as to seal against the housing itself. Again, the suitable dimensions and properties of the seals 32a, 32b recesses 38, 40 and inner surface 28i are easily derived by those skilled in the art and are not, therefore, described in more detail herein.

The jacket 26 may include an axial location member 42 at a first (inner) end 26f of the jacket 26 such as a circumferentially extending and radially outwardly projecting step 42 on an outer diameter thereof for engagement with a corresponding location member 44 formed as, for example, a projection extending radially inwardly from an inner surface 28i of an aperture 28 in said casing 12 which, in operation, prevents the jacket 26 passing too far in a first direction FD into the aperture 28 and into the interior of the casing itself. It will be appreciated that a lower inwardly facing surface of step 42 engages with an upper outwardly facing surface of said location member 44 and thus prevents movement into the casing itself.

A second axial location member 46 is provided on a second (outer) end 26s of the jacket 26 and preferably comprises a first circumferentially extending step 46 on an outer diameter 26o of the jacket 26 and a corresponding location member or lip 48 provided on a cover 50 provided for covering the electrical connectors themselves. Whilst a small gap G may be provided such as to allow for a limited degree of axial movement of the jacket 26 relative to the cover 50, the cover effectively acts to limit that movement in a second direction SD out of said aperture 28 such as to retain the connector assembly 10 within an assembled position, as shown in FIG. 2. The cover 50 may further include a securing member in the form of, for example, bolts 52 for securing the cover 50 to the casing 12. The body portion may further be provided with a securing means 52 for securing the body portion 14 within the jacket 26. Whilst a number of securing means 52 are possible, it has been found that a simple circlip 52c insertable into a circumferentially extending recess 54 on an extension 14e on the body portion 14 that extends beyond the jacket 26 in a manner that allows the circlip 52c to engage with the recess 54 and a top portion 26t of said jacket for restricting or preventing axial movement of the body portion 14 relative to the jacket 26. An anti-rotation member for the jacket 26 is shown in FIG. 4 generally at 27 for preventing or restricting rotation of the jacket 26 within the cover 50. A particular arrangement may comprise a flat portion 27i provided on an outer surface of the jacket 26 and a corresponding flat portion 27o is provided on an inner surface 50i of the cover 50 which, in operation, cooperate with each other to prevent rotation.

The above arrangement may further include an anti-rotation member shown generally at 56 for preventing or restricting rotation of the body 14 within the jacket 26. A particular arrangement may comprise a flat portion 56i provided on an outer surface 14o of the body 14 and a corresponding flat portion 56o provided on an inwardly facing surface 26i the jacket 26 which, in operation, cooperate with each other to prevent rotation. Other forms of anti-rotation systems may be used. Also shown is a connector securing member in the form of, for example, a bolt 58 insertable and securable into a threaded portion 60 in the body 14. An electrical cable 62 from, for example, the coils 4 is secured to the body on an inner first end thereof 16 and may be soldered or otherwise secured in position.

Referring now more particularly to FIG. 3 which illustrates the arrangement of FIG. 2 in exploded form, it will be appreciated that the arrangement may further include electrically insulating sidewalls 50s between the multiple connectors 10 as well as an optional coverplate 64 which extends over the top of the insulating sidewalls 50s. A conventional terminal box 66 having appropriate holes 68 for the electrical cables 24 may also be provided around the connectors 10 and may be secured to the casing 12 by means of bolts 70. An access panel 72 may be provided on an outer surface of the terminal box 66 with an access point and may be secured by bolts 74 and sealed with a seal 76.

Assembly of the above-mentioned arrangement will now be described with reference to both FIGS. 2 and 3 and commences with assembling the coils 4 into the casing 12 such as to allow their respective leads 62 and associated body portions 14 to lie adjacent aperture 28. This is achieved by inserting the body portions 14 from the interior of the casing 12 and through the aperture 28 in the direction of arrow SD in FIG. 2. The individual body portions 14 are effectively inserted through their own individual apertures 28a, 28b, 28c (best seen in FIG. 3) and are thus then positioned relative to each other before their respective outer jackets 26 are inserted over them in the direction of arrow FD such as to allow each body portion 14 to engage the anti-rotation features 56i, 56o and to allow the second end 18 to protrude beyond the top 26t of the jacket 26 itself. The location member 42 at the first ends 26f of the jackets now engage with the corresponding feature 44 on the casing such as to prevent the jacket 26 passing further into the casing itself. The body portions 14 may now be secured by inserting circlip 52c into recess 54 before cover 50 is placed over one or more of the assembled components and secured to the casing by bolts 52. The location members 46, 48 now act to prevent inadvertent removal of the jacket/body portion assembly 26/14.

The terminal box 66 is now secured to the casing 12 by bolts 70 before the electric cables 24 are inserted through apertures 68 and secured to their respective body portions 14 by means of bolts 58. The coverplate 64 is then placed over the assembly before seal 76 is positioned over the terminal box 66 and coverplate 72 secured in position by bolts 74, thus covering aperture 78.

It will be appreciated that the above arrangement and assembly method will allow for the arrangement to be dismantled without requiring access to the inside of the casing. Indeed, all seals may be inspected and replaced if necessary without requiring access to the inside of the casing itself. The process of disassembly is simply the reverse of the above and it will be appreciated that once jacket 26 is removed seals 30a, 30b can be inspected and replaced if necessary. Indeed, seals 32a, 32b may also be inspected and replaced if needed. It will be further appreciated that individual body portions 14 can be accessed for inspection purposes. This is in stark contrast with the arrangement of the prior art which effectively requires destruction of the entire sealing arrangement and the re-creation thereof if just one electrical cable is not correctly sealed. The reader will appreciate that the anti-rotation feature 56i on the body portion allows for the re-assembly of the jacket 26 thereover by simply sliding the jacket onto the body portion 14. No relative rotation is required and, hence, one does not need access to the body portion 14 in order to prevent rotation thereof. The jacket 26 and the body portion 14 are then both secured in place by the same retaining means 52 in the form of, for example, circlip 52c.

It will be appreciated that individual items described above may be used on their own or in combination with other items shown in the drawings or described in the description and that items mentioned in the same sentence as each other or the same drawing as each other need not be used in combination with each other. In addition the expression “means” may be replaced by actuator or system or device as may be desirable. In addition, any reference to “comprising” or “consisting” is not intended to be limiting any way whatsoever and the reader should interpret the description and claims accordingly.

1. An electrical connector comprising an electrically conductive body portion having a first end for receiving an electrical input and a second end for connection to a further electrical connection, wherein said connector further comprises an outer insulating jacket around an outer diameter of said body portion for insertion into a recess in an outer surface of a casing through which it is desired to pass the electrical connection and wherein said jacket includes a first axial location member at a first end for engagement with a location member in said recess for prevention of movement in a first inward direction and a second axial location member at a second end of said jacket for engagement with a second axial location member provided on a cover securable to an outer surface said casing for preventing axial movement of said jacket in a second outward direction.

2. The electrical connector of claim 1 and including a first anti-rotation member for preventing rotation of said body within said jacket.

3. The electrical connector of claim 2, wherein said first anti-rotation member includes a flat portion provided on the body and a corresponding flat portion on the jacket.

4. The electrical connector of claim 1, comprising a second anti-rotation member for preventing rotation of said jacket within said cover.

5. The electrical connector of claim 4, wherein said second anti-rotation member comprises a flat portion on said jacket and a flat portion on said cover.

6. The electrical connector of claim 1, wherein said body portion includes a first, inner, fluid seal between it and the insulating jacket and wherein said insulating jacket includes a second, outer, fluid seal for sealing between it and a housing through which it may be passed.

7. The electrical connector of claim 6, wherein said first, inner, seal comprises a compression seal.

8. The electrical connector of claim 6, wherein said inner seal comprises one or more deformable seal or seals having a width W and said body portion includes one or more circumferentially extending recesses for receiving said one or more seals and having a depth D less than the width W, and wherein said jacket includes an inner diameter greater than an outer diameter of said body portion such as to cause said seals to be compressed upon insertion of the body portion into the jacket.

9. The electrical connector of claim 6, wherein said second, outer seal comprises a compression seal.

10. The electrical connector of claim 6, wherein said second outer seal comprises one or more deformable seal or seals having a width W2 and said jacket includes one or more circumferentially extending recesses for receiving said one or more seals and having a depth D2 less than the width W2, for sealing against a casing.

11. The electrical connector of claim 1, comprising a casing having an aperture through which said connector passes, an inner surface against which said outer seal may engage for sealing, and a corresponding circumferentially extending lip extending from an inner surface of an aperture in said casing and forming said location member.

12. The electrical connector of claim 1, wherein said first axial location member comprises a circumferentially extending lip extending around an outer diameter of said insulating jacket for engagement with a corresponding circumferentially extending lip extending from an inner surface of an aperture in said casing.

13. The electrical connector of claim 1, wherein said second axial location member comprises a circumferentially extending lip extending around an outer diameter of said insulation jacket for engagement with a corresponding circumferentially extending lip on a cover to said casing.

14. The electrical connector of claim 1 comprising a cover for fitment over said jacket and a circumferentially extending lip for engagement with a corresponding circumferentially extending lip on said jacket and being securable to an outer surface of the casing.

15. The electrical connector of claim 1, comprising a securing member for securing said body portion within said jacket when inserted therein and for preventing axial movement thereof.

16. The electrical connector of claim 1, wherein said body portion extends beyond an end of said jacket and said body portion and includes a securing member for securing the body portion within the jacket.

17. The electrical connector of claim 16, wherein said securing means comprises a circumferentially extending recess on said body portion for receiving a circlip for engagement with both of said body portion and said jacket to restrict axial movement of said body portion relative to said jacket.

18. The electrical connector of claim 1, comprising a connector securing member for securing an electrical connection to said body portion.

19. The electrical connector of claim 18, wherein said body portion comprises a threaded portion and the securing member comprises a bolt for engagement in said threaded portion,

20. A method of assembling an electrical assembly of claim 1, comprising the steps:
e) inserting said body portion through an aperture in a casing from an inner side thereof;
f) inserting said jacket over said body portion from an outer side thereof;
g) securing said body portion within said jacket; and
h) securing said jacket within said casing.
